(19) United States
(12) Patent Application Publication
(10) Pub. No.: US 2024/0300456 A1
(43) Pub. Date: Sep. 12, 2024

(54) BRAKE PEDAL SYSTEM FOR A MOTOR VEHICLE

(71) Applicant: CJ AUTOMOTIVE AB, 514 63 DALSTORP (SE)

(72) Inventor: Carl Johan WESCHKE, Dalsjöfors (SE)

(73) Assignee: CJ AUTOMOTIVE AB, 514 63 DALSTORP (SE)

(21) Appl. No.: 18/268,345

(22) PCT Filed: Sep. 28, 2021
(86) PCT No.: PCT/SE2021/050945

§ 371 Date: Jun. 20, 2023

(51) Int. Cl. B60T 7/04; B60T 7/06; B60T 8/171

(52) U.S. Cl. CPC B60T 7/042; B60T 7/06; B60T 8/171; G05G 1/38; B60T 2220/04; B60T 2270/402; B60T 2270/404; B60T 2270/413

(57) ABSTRACT

A brake pedal system for a motor vehicle includes a bracket, a pedal arm pivotally coupled to the bracket at a pivot point, and a first, second and third systems. The first system is arranged for simulating a pedal feel, the second system for sensing a pedal angle to electronically control a braking force by sending a first signal to a vehicle ECU and the third system is arranged for sensing at least a pedal force to electronically control a braking force by sending a second signal to a vehicle ECU. The second or the third system may be used as a master system for the braking control and the other as a slave, for achieving double security, and the first system together with the third system may be used to define the pedal feel.

### BACKGROUND AND SUMMARY

The invention considers a brake pedal system for a motor vehicle.

Historically, motor vehicles such as cars had a purely mechanical pedal system for brakes, clutches and accelerator pedals. Nowadays, car manufacturers are moving from mechanical pedal systems to electrical pedal systems. In electrical pedal systems, the car is controlled from a computer-controlled system, often called ECU-Electronic Control Unit, actuated from the pedals in the car maneuvering different sensors. For example, the brake system may be controlled depending on the position of the brake pedal in relation to a position sensor, which position sensor sends signals to the ECU, which in turn controls the brake force as a response of the brake position. Position sensors may be of different kind, such as linear sensors which measure a linear distance of the pedal move, or rotation sensors which measure for example a rotation of an electric motor, like the solution disclosed in US 2015/070003 A1. Another type of rotation sensor is an angle sensor, for detection of rotation angle of a vehicle pedal around its axis of rotation. Such a solution is for example presented in EP 2 926 090 BI.

Further, in the electrical pedal systems, there is a need to simulate for the driver a purely mechanical pedal system so that the driver perceives that when he/she e.g. depresses for example the brake pedal, the brake system behaves as he/she is used to. This is important so that the driver feels comfortable behind the steering wheel. Such systems are known as “pedal feel simulating systems” and one example is presented in EP 3 264 218 B1. These systems normally also act as the “brake booster” if the pedal is a brake pedal. In for example older hydraulic systems, a system of one or more springs were connected to the pedal and the hydraulic system, where a braking force was transferred via the “booster” springs to the hydraulic system to “boost” the braking force in response to the braking force.

In some prior art solutions, there is also another type of sensor for controlling the brake function, namely a pedal force sensor. US 2018/0215368 A1 shows a brake unit with a pedal which is rotatably mounted around one shaft at one end. The pedal mechanism comprises a first sensor unit which is connected to a first brake system and a second sensor unit which is connected to a second brake system. The first sensor unit comprises first force and motion sensors attached on the pedal, wherein the motion sensor is a rotation sensor, and the force sensor is a pressure sensor. The second sensor unit is arranged on a reaction force generating mechanism which generates a reaction force against the force which the driver applies to the pedal. The second sensor unit comprises second force and motion sensors, wherein the motion sensor may be a potentiometer or rotation sensor, and the force sensor is a pressure sensor. The first force and motion sensors are connected to a first ECU, which controls the braking function via the first brake system. The second force and motion sensor are connected to a second ECU, which controls the braking system via the second brake system. The first brake system controlled by the first ECU is a main system while the second brake system controlled by the second ECU is a backup system.

Some drawbacks with existing electrical pedal systems are the following Since a failure of an electric system is a great risk, different backup systems are used to secure the braking function in the event of a failure in the electrical brake system. Prior art solutions either have a hydraulic backup sensor where like a brake booster system, where a first system is some kind of electronic sensor system (rotation sensor, angle sensor or the like) and the second system is connected to the pedal force where the brake force is transferred to a second, hydraulic system. The other type, like the one presented above in the patent application US 2018/0215368 A1, which is purely electronic, has different systems, one main system and one backup system. Having two systems is of course quite expensive and entails complicated solutions to provide a totally secure brake system. Another drawback with existing pedal feel simulating systems is that they are limited to the properties of the pedal feel system itself, like for example a single spring with a spring constant in combination with a stroke of the pedal feel arrangement, which gives a limited variation possibilities of the pedal feel. Different car manufacturers have different demands on how the “feel” should be perceived, why a limited number of combinations is a drawback for a producer who delivers to different manufacturers. Thus, there is a need of a simple system which is cost efficient but still very secure, to ensure a secure and fully electronic brake pedal system, and with a great freedom of how to design the pedal feel of the brake pedal.

It is desirable to address at least some of the problems and issues outlined above.

According to an aspect of the present invention, a brake pedal system for a motor vehicle is disclosed. The brake pedal system comprises a bracket, a pedal arm which is pivotally coupled to the bracket with a first end at a pivot point. The pedal arm further comprises a second end distal from the first end, and which second end is a free end and comprises a pedal plate. The pedal plate is arranged to be subjected to a braking force applied by a driver of the vehicle so that the pedal plate is pushed, and the pedal arm rotates around the pivot point.

The brake pedal system further comprises, according to an aspect of the invention, a first system for simulating at least a pedal feel, which first system comprises a compressible first elongated device for dampening a pivotal movement of the pedal arm around the pivot point, wherein the first elongated device has a longitudinal extension between a first end part coupled to the pedal arm at a first position on the pedal arm, and a second end part coupled to the bracket at a first position on the bracket. The first elongated device comprises at least a first spring parallel to the longitudinal extension of the first elongated device.

The brake pedal system further comprises, according to an aspect of the invention, a second system for sensing a pedal angle, which second system comprises a movable first part, which in use accompanies the rotational motion of the pedal arm and a stationary second part, wherein the first and the second part are to be arranged radially outside of the pivot point. A magnetic field sensing component is arranged in the first or in the second part, and a magnetic element arranged in that part of the first or the second part that does not comprise the magnetic field sensing component. The magnetic field sensing component is arranged to generate a first electric signal originating from magnetic interaction between the first and the second part when the first and the second part are moving in relation to each other. Preferably the first part is coupled to the second part so that the motion of the first part is controlled in relation to the second part.

The brake pedal system further comprises, according to an aspect of the invention, a third system for sensing at least a pedal force. The third system comprises a force sensor arranged at the bracket in a second position on the bracket, a compressible second elongated device which has a longitudinal extension between a first end part coupled to the pedal arm at a second position on the pedal arm, which is different from the first position, and a second end part connected to the force sensor. The second elongated device comprises at least a second spring parallel to the longitudinal extension of the second elongated device and which extends between the first end part and the second end part. The pedal force sensor is arranged to generate a second signal originating from a pedal force acting on the pedal arm and transferred to the force sensor via the second elongated device.

Such brake pedal system provides a secure electronic brake system with double security as well as a great freedom of how to design the pedal feel of the brake pedal without the need of additional mechanical or hydraulic system for extra security or for the pedal feel of the brake pedal.

The double security is achieved, according to an aspect of the invention, by the combination of the second system for sensing the pedal angle and the third system for sensing at least the brake force applied on the pedal plate. Any of the systems may be the master or the slave (backup) system of the other and since both systems are arranged to generate a signal to the vehicle Electronic Control System (ECU), the ECU handles the signals to transfer them to a braking operation, in response to the angle of the pedal arm and/or in response to the brake force applied on the pedal plate/pedal arm. If one of the systems fails/is not functioning and no signal is generated, the ECU registers that and the braking functions still is achieved via the signal from the other system. Prior art systems either have one electric system with electronic sensors and one mechanical or hydraulic system for backup, or two separate brake systems controlled by separate sensor systems. The inventive brake pedal system may, according to an aspect of the invention, be operated by one braking system, with need of only one ECU, controlled by two different sensor systems, which gives a simpler and cheaper solution but still with double security.

The pedal feel function of the brake pedal system presented above provides, according to an aspect of the invention, a great freedom in the setup of the pedal feel response, since the first system for sensing the pedal feel is complemented by the third system, which not only may be arranged for sensing the pedal force, but which also may be used in combination with the first system for setting up the total pedal feel of the brake pedal. Since both the first and the third system each comprises an elongated device with at least one spring, and that the elongated device of the first system is arranged between the bracket and the pedal arm at one position, and the elongated device of the third system is arranged between the bracket and the pedal arm in a second position, both systems are to be combined to set up the pedal feel curve. Of course, the attachment positions to the bracket and the pedal arm may be more or less the same for the two systems, but may also be different, with different lengths, angles etc. of the respective elongated device of the two systems. Since the spring constant as well as the positions on the bracket and the pedal arm of the respective first and third systems are used to design the pedal feel curve, the brake response/resistance and the hysteresis of the pedal feel curve may be designed with a great number of combinations, to meet the demands of different vehicle manufacturers. No prior art solutions provide such a system with all the presented advantages combined into one single electronic braking system.

According to an embodiment, the second system is arranged to send the first electric signal of the second system to a vehicle ECU as a response to a brake request to control a braking action, and the third system is arranged to send the second electric signal of the third system to the vehicle ECU as a response to a brake request.

According to an embodiment, the second system is arranged to act as a master system wherein the first electric signal of the second system is sent to a vehicle ECU as a response to a brake request to control a braking action, and the third system is arranged to act as a backup system of the second system, wherein the second electric signal of the third system is sent to the vehicle ECU as a response to a brake request, wherein the second electric signal of the third system is used to control a braking action if the first electric signal of the second system is not sent to the vehicle ECU. The vehicle ECU may be programmed in different ways of how to handle the signals of the second and the third systems, for example, the signals from the master system is always used and the signals from the slave system is ignored unless the master system fails to send a signal. Another option would be that the signals from both system always is registered and compared and a failure of one system curve (not predefined response) will cause the ECU to control the braking function by the correct curve etc. A lot of combination possibilities is possible to control the braking function with one ECU provided with signals from the second and the third systems.

According to an embodiment, the vehicle ECU is a first ECU and a second ECU, wherein the first electric signal of the second system is sent to a first vehicle ECU, and the second electric signal of third system is sent to a second vehicle ECU. By such a system, it is possible to separate the safety systems from each other and also to separate the pedal feel system from the safety systems.

According to an embodiment, the first position on the pedal arm, to which the first elongated device of the first system is coupled to the pedal arm with its first end part, is arranged between the first and the second end of the pedal arm at a first distance from the pivot point, and the at least one first spring of the first elongated device of the first system has a first spring rate, wherein the first distance and the first spring rate of the at least one first spring together defines a first pedal feel curve of the brake pedal of the brake pedal system. The at least one first spring may be several springs arranged on the first elongated device, to provide a wanted pedal feel curve. Further, the elongated device of the first system may comprise other parts such as sleeves, friction elements etc. which together with the spring/springs is arranged to achieve the pedal feel curve of the first system of the brake pedal system.

According to an embodiment, the second position on the pedal arm, to which the second elongated device of the third system is coupled to the pedal arm with its first end part, is arranged between the first and the second end of the pedal arm at a second distance from the pivot point, and the at least one second spring of the second elongated device of the third system has a second spring rate, wherein the second distance and the second spring rate of the at least one second spring together defines a second pedal feel curve of the brake pedal of the brake pedal system. Further, the elongated device of the third system may comprise other parts such as sleeves, friction elements etc. which together with the spring/springs is arranged to achieve the pedal feel curve of the third system of the brake pedal system.

According to an embodiment, the first pedal feel curve of the first system and the second pedal feel curve of the third system together defines a total pedal feel curve of the brake pedal of the brake pedal system.

According to an embodiment, the first position on the pedal arm, to which the first elongated device of the first system is coupled to the pedal arm with its first end part, is arranged on a first side of the pedal arm, and the second position on the pedal arm, to which the second elongated device of the third system is coupled to the pedal arm with its first end part, is arranged on a second side of the pedal arm, which second side is opposite the first side of the pedal arm. By arranging the elongated devices of the first and the third systems on respective sides of the pedal arm, a greater freedom in positioning the elongated devices on the bracket and on the pedal arm is achieved.

According to an embodiment, the pedal arm comprises at least one shaft which extends through the pedal arm at the first position and the second position on the pedal arm. This means that the elongated device of the first system is coupled to the pedal arm at a common shaft to which also the second elongated device of the third system is coupled, which provides a simple solution of coupling the elongated devices to the pedal arm.

According to an alternative embodiment, the pedal arm comprises at least two shafts, wherein one shaft is arranged on the first side of the pedal arm in the first position on the pedal arm, and the other shaft is arranged on the second side of the pedal arm in the second position on the pedal arm. Such a solution provides a freedom in attaching the respective elongated devices of the first and the third systems to the pedal arm, wherein a great variation in adapting the pedal feel curve is achieved.

According to an embodiment, the first end part of the second elongated device of the third system comprises a first guide which protrudes towards the second end part of the second elongated device, and the second end par comprises a second guide which protrudes towards the first end part of the second elongated device, wherein the first and second guides are telescopically arranged relative each other, and wherein the second spring of the second elongated device is arranged radially outside the first and second guides. By such a solution, a linear motion of the force sensing system (the third system) gets a guided and controlled motion towards the force sensor.

According to an embodiment, the compressible first elongated device of the first system further comprises a first guide, which is firmly connected to first end 31 and protrudes towards the second end and a second guide, which is firmly connected to the second end and protrudes towards the first end of the elongated device. The first and second guides are telescopically arranged relative each other wherein the first guide encloses a part of the second guide. Further, the at least one first spring is a number of coil springs, wherein a first coil spring is arranged around at least a part of the first guide and a second coil spring is arranged around at least a part of the second guide. Further, a first sleeve is arranged around at least a part of the first coil spring, and a second sleeve is arranged around at least a part of the second coil spring. The first coil spring is clamped between the first end of the elongated device and an inside end of the first sleeve, and the second coil spring is clamped between the second end of the elongated device and an inside end of the second sleeve. The elongated device further comprises a third coil spring which is arranged around at least a part of the first and second sleeves and which is clamped between first and second sleeves.

According to an embodiment, the brake pedal system further comprises one or more friction elements arranged between at least one of the first and second coil springs and the corresponding enclosing first and second sleeves. Such friction element may be a leaf spring or the like, which causing an increased friction between the coil spring and the surrounding sleeve when the coil spring is compressed, which further adds design possibilities to the overall pedal feel.

Further possible features and benefits of this solution will become apparent from the detailed description below.

### BRIEF DESCRIPTION OF DRAWINGS

The solution will now be described in more detail by means of exemplary embodiments and with reference to the accompanying drawings, in which:

FIG. 1a is a perspective view from a first side of a brake pedal system according to an embodiment of the invention.

FIG. 1b is a section view of a first system for simulating a pedal feel of the brake pedal system.

FIG. 1c is a close-up view of FIG. 1a, showing the first system for simulating a pedal feel.

FIG. 2a is a perspective view of the brake pedal system from a second side which is opposite the first side shown in FIG. 1a.

FIG. 2b-c are section views from the second side showing sections in front of and behind a bracket part, for showing a third system (pedal force) in detail as well as showing a second system (pedal angle) in an overview.

FIG. 3a-c shows details of the second system (pedal angle).

### DETAILED DESCRIPTION

Briefly described, a “stand alone” and secure brake pedal system is provided that gives a cost-efficient solution for simulating, in an electrically controlled brake pedal system, the feel of a mechanical/hydraulic brake pedal system to a driver pressing the pedal of the electrically controlled brake pedal system. Further, the system provides a double security without the need of an extra vehicle ECU-only one ECU is needed. This is achieved by combining a first system arranged for simulating at least a pedal feel, a second system arranged for sensing e pedal angle, and a third system arranged for sensing at least a pedal force, where the third system also is preferred to simulating the pedal feel together with the first system.

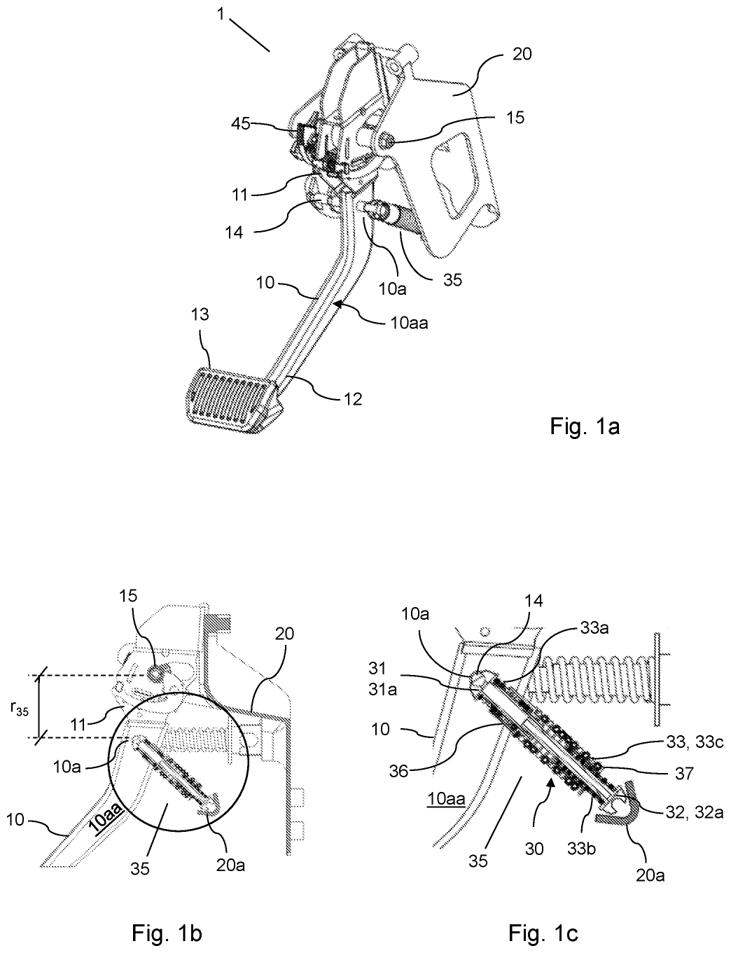

FIG. 1a shows a perspective view from a first side of a brake pedal system 1 according to an embodiment. FIG. 1b is a section view of a first system 35 for simulating a pedal feel of the brake pedal system, and FIG. 1c is a close-up view of the first system 35.

The brake pedal system 1 comprises a pedal arm 10 pivotally connected via a pivot point 15 to a bracket 20 of a motor vehicle. The pivot point 15 is realized as a pivot shaft on which a first end 11 of the pedal arm 10 is pivotally connected to the bracket 20. The pedal arm 10 has, at its second end 12, which is distal to the first end 11, a foot pedal plate 13 onto which a driver of the vehicle is to press when maneuvering the pedal arm 10. The first system 35 for simulating at least a pedal feel, is arranged at the first side 10aa of the pedal arm 10 and faces the viewer of FIG. 1a. The first system 35 comprises a compressible first elongated device 30 for dampening a pivotal movement of the pedal arm 10 around the pivot point 15, wherein the first elongated device 30 has a longitudinal extension between a first end part 31 coupled to the pedal arm 10 at a first position 10a on the pedal arm 10 and a second end part 32 coupled to the bracket 20 at a first bracket position 20a on the bracket 20. More precise, the first end part 31 is connected to a shaft 14, which is arranged at the first position 10a and connected to the pedal arm 10 and protruding from a first side 10aa of the pedal arm 10. The first position 10a is arranged between the first end 11 and the second end 12 of the pedal arm 10 at a first distance r35 from the pivot point 15. Preferably, the shaft 14 extends through the pedal arm 10 from the first side 10aa of the pedal arm 10 and to an opposite second side 10bb of the pedal arm 10. The first elongated device 30 comprises at least one first spring 33 parallel to the longitudinal extension of the first elongated device 30, wherein the at least one first spring 33 has a first spring rate k33. The first distance r35 from the pivot point 15 to the first position 10a on the pedal arm and the first spring rate k33 together defines a first pedal feel curve of the brake pedal 10 of the brake pedal system 1. Of course, the pedal feel curve also depends on the position of where the second end part 32 of the first elongated device 30 is coupled to the bracket 20 in the first bracket position 20a and the length of the first elongated device 30.

As can be seen in FIG. 1b-c the at least one first spring 33, is in one embodiment preferred to be a number of coil springs 33a, 33b, 33c and the first elongated device 30 of the first system 35 preferably comprises a first sleeve 36 and a second sleeve 37 arranged for guiding the springs. The first elongated device 30 further comprises a first guide 31a, which is firmly connected to first end 31 and protrudes towards the second end 32, and a second guide 32a, which is firmly connected to the second end 32 and protrudes towards the first end 31 of the elongated device 30. The first and second guides 31a, 32a are telescopically arranged relative each other wherein the first guide 31a encloses a part of the second guide 32a. A first spring coil 33a is arranged around the first guide 31a and the first sleeve 36 is in turn arranged around at least a part of the first coil spring 33a. The first coil spring 33a is clamped between the first end 31 of the elongated device 30 and an inside end of the first sleeve 36. A second coil spring 33b arranged around the second guide 32a and the second sleeve 37 is in turn arranged around at least a part of the second coil spring 33b. The second coil spring 33b is clamped between the second end 32 of the elongated device 30 and an inside end of the second sleeve 37. A third coil spring 33c is arranged around at least a part of the first and second sleeves 36, 37 and is clamped between them. The springs 33a-c and the sleeves thereby are combined to build up a desired pedal feel of the brake pedal 10. The first elongated device 30 may also comprise friction elements to add even more settings to the pedal feel of the brake pedal. Other possibilities are to design/use sleeves 36, 37 of different material or coat their sliding surfaces to create different coefficients of friction to impact the hysteresis curve. When attaching the compressible first elongated device 30 between the pedal arm 10 and a bracket 20/chassis of the motor vehicle, the compressible first elongated device 30 can be compressed when the driver presses the foot pedal plate 13. The at least one first spring 33, in one embodiment the springs 33a-c of the compressible first elongated device 30 provides a counter force to the force provided by the driver when pressing the pedal arm 10. Further, if there is a friction element arranged between a first housing/sleeve and for example a second housing/sleeve of the compressible first elongated device 30, the friction element counteracts the compressing and de-compressing movement of the first elongated device 30 due to a frictional force that the friction element provides when the first and second housing moves in relation to each other in the direction of the first elongated device 30. The friction element provides a hysteresis to the movement of the pedal up and down in relation to the force that the driver exerts to the pedal, which is similar to the hysteresis that a driver experiences in a purely mechanical/hydraulic pedal system. As mentioned, this hysteresis is also possible to achieve by the choice of material in the sleeves 36, 37.

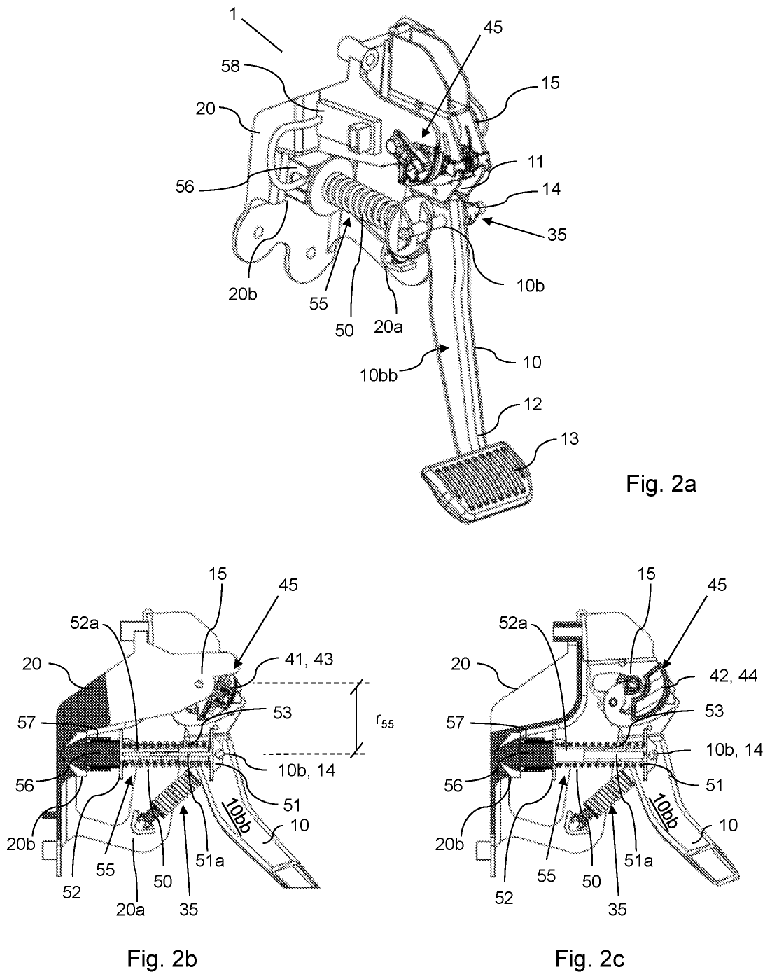

FIG. 2a shows a perspective view from a second side of the brake pedal system I of FIG. 1, which is an opposite side of the brake pedal system 1. FIG. 2b-c are section views from the second side showing sections in front of and behind a bracket part, for showing a third system 55 (pedal force) in detail as well as showing the second system 45 (pedal angle) in an overview.

The brake pedal system I comprises the third system 55 for sensing at least a pedal force, which is visible in FIG. 2a-c. The third system comprises a force sensor 56, which is arranged at the bracket 20 in a second position 20b on the bracket 20. Preferably, the force sensor 56 is arranged in a housing 57, which is securely attached to the bracket 20. The force sensor 56 is in turn connected with a wire to a connector 58 and a sensor Printed Circuit Board. The third system 55 further comprises a compressible second elongated device 50 which has a longitudinal extension between a first end part 51, which is coupled to the pedal arm 10 at a second position 10b on the pedal arm 10, which in the preferred embodiment is the common shaft 14, which also protrudes from the second side 10bb of the pedal arm 10, as described above. The second position 10b is in this embodiment different from the first position 10a, since it is arranged on the opposite side of the pedal arm 10, but the second position 10b may also be different in that way that the shaft 14 may be two different shafts (not shown here), which are arranged at different distances relative the pivot point 15, depending on the design criterions for a certain car manufacturer. The compressible second elongated device 50 further comprises a second end part 52, which is connected to the force sensor 56, and further the second device 50 comprises a second spring 53 parallel to the longitudinal extension of the second elongated device 50 and extending between the first end part 51 and the second end part 52. The pedal force sensor 56 is arranged to generate a second signal which originates from a pedal force acting on the pedal arm 10 (pedal plate) and transferred to the force sensor 56 via the second elongated device 50. Preferably, the first end part 51 of the second elongated device 50 comprises a first guide 51a, which protrudes towards the second end part 52 of the second elongated device 50, and the second end part 52 comprises a second guide 52a, which protrudes towards the first end part 51 of the second elongated device 50. The first and second guides 51a, 52a are telescopically arranged relative each other, and the second spring 53 of the second elongated device 50 is arranged radially outside the first and second guides 51a, 52a.

The second position 10b on the pedal arm 10, to which the second elongated device 50 is coupled to the pedal arm 10 with its first end part 51, is arranged between the first and the second end 11, 12 of the pedal arm 10 at a second distance r55 from the pivot point 15. As mentioned above, it is preferred to have a common shaft 14, wherein the second distance r55, of the third system 55 may be similar with the first distance r35 of the first system 35.

The at least one second spring 53 of the second elongated device 50 of the third system 55 has a second spring rate k53, wherein the spring rate, together with the positioning of the second elongated device 50 on the bracket 20 and the pedal arm 10, (second position 20b on the bracket 20, second position 10b on the pedal arm 10) respectively and the total length of the second elongated device 50, all together defines the properties of the pedal force function. Additionally, the second elongated device 50 is preferably used also to add design possibilities to the pedal feel of the brake pedal system 1. This is achieved by combining the first system 35 with the third system 55 according to the inventive concept. The second distance r55 and the second spring rate k53 of the at least one second spring 53 together defines also a second pedal feel curve of the brake pedal 10. Of course, the pedal feel curve of this third system 55 also depends on the position of where the second end part 52/the housing 57 of the second elongated device 50 is coupled to the bracket 20 in the second position 20b and the length of the second elongated device 50. The first and the third systems 35, 55 thereby are used to define the counter force to the force provided by the driver when pressing the pedal arm 10, as well total pedal feel of the brake pedal system 1. The latter discloses the pedal feel and hysteresis to the movement of the pedal up and down in relation to the force that the driver exerts to the pedal, which is similar to the hysteresis that a driver experiences in a purely mechanical/hydraulic pedal system.

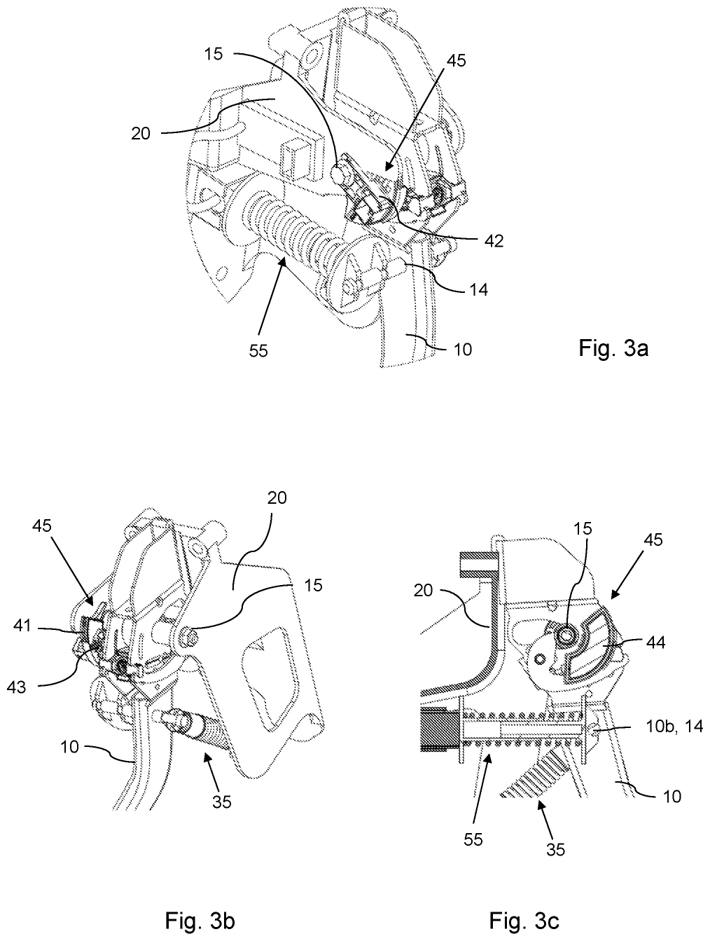

FIG. 3a-c shows details of the second system 45 of the invention, which main concept and details are described in WO 2014/084791 A1, filed by the applicant. The brake pedal system 1 according to the invention thus further comprises the second system 45 for sensing a pedal angle. The second system 45 comprises a movable first part 41, which in use accompanies the rotational motion of the pedal arm 10 and a stationary second part 42. The first and the second part 41, 42 are arranged radially outside of the pivot point 15 as may be seen in the figures. A magnetic field sensing component 43 is arranged in the first 41 or in the second part 42 and a magnetic element 44 is arranged in that part of the first or the second part 41, 42 that does not comprise the magnetic field sensing component 43. The magnetic field sensing component 43 is arranged to generate a first electric signal which originates from magnetic interaction between the first and the second part 41, 42 when the first and the second part are moving in relation to each other.

The movable first part 41 may directly, or through a link, be coupled with the pedal shaft and by that accompany the rotational motion and the stationary second part 42, may be fastened in the vehicle chassis through the bracket 20. Preferably, the first part 41 is coupled to the second part 42 so that the motion of the first part 41 is controlled in radial direction in relation to the second part 42. The magnetic field sensing component 43 may be for example of Hall or Reed type. The “angle sensor” (the second system 45) detects the magnetic field depending on where the magnetic element 44 is in relation to the magnetic field sensing component 43. Depending on the different magnetic field sensing components 43 different signals result, corresponding to a certain rotation of the vehicle pedal is achieved. The signals can be partly digital (on/off) or linear over the motion. For example, the second part 42 may comprise a printed circuit card, in which the magnetic field sensing component 43 is placed, and a sensor housing. The sensor housing is preferably designed as a disk or as part of a circle which has an extension in a direction along the circumference of the pedal shaft/the pivot point 15. The device can deliver one or several types of position signals depending on the design of the printed circuit card. The signals can be of either digital or analogous character or a combination if desired.

On top of the above described advantages regarding the three systems 35, 45, 55, a double security is achieved via the second and the third systems 45, 55. The second system 45 is arranged to send the first electric signal of the second system 45 to a vehicle ECU (Electronic Control Unit) as a response to a brake request to control a braking action, which brake request (e.g. the force provided by the driver when pressing the pedal arm 10/pedal plate 13) results in an angle change detected by the second system 45. The third system 55 is arranged to send the second electric signal of the third system 55 to the vehicle ECU as a response to a brake request, which is a result of the force subjected to the pedal arm 10/pedal plate 13, and which results in a signal detected by the pedal force sensor 56 of the third system 55, and which signal is dependent on the force “level”.

According to the preferred embodiment, the second system 45 (pedal angle) is arranged to act as a master system wherein the first electric signal of the second system 45 is sent to a vehicle ECU as a response to a brake request to control the braking action, and the third system 55 is arranged to act as a backup system of the second system 45, wherein the second electric signal of the third system 55 is sent to the vehicle ECU as a response to a brake request. The second electric signal of the third system 55 is used to control a braking action if the first electric signal of the second system 45 is not sent to the vehicle ECU. The vehicle ECU may of course be programmed in different ways of how to handle the signals of the second and the third systems 45, 55, for example, the signals from the master system is always used and the signals from the slave system is ignored unless the master system fails to send a signal. Another option would be that the signals from both systems always are registered and compared and a failure of one system curve (not predefined response) will cause the ECU to control the braking function by the correct curve etc. A lot of combination possibilities is possible to control the braking function with one ECU provided with signals from the second and the third systems 45, 55.

In another embodiment, the vehicle ECU is a first ECU and a second ECU, wherein the first electric signal of the second system 45 is sent to a first vehicle ECU, and the second electric signal of third system 55 is sent to a second vehicle ECU, to separate the systems from each other.

Although the description above contains a plurality of specificities, these should not be construed as limiting the scope of the concept described herein but as merely providing illustrations of some exemplifying embodiments of the described concept. It will be appreciated that the scope of the presently described concept fully encompasses other embodiments which may become obvious to those skilled in the art, and that the scope of the presently described concept is accordingly not to be limited. Reference to an element in the singular is not intended to mean “one and only one” unless explicitly so stated, but rather “one or more.” All structural and functional equivalents to the elements of the above-described embodiments that are known to those of ordinary skill in the art are expressly incorporated herein and are intended to be encompassed hereby.

1. A brake pedal system for a motor vehicle, the system comprising:
a bracket,
a pedal arm pivotally coupled to the bracket with a first end at a pivot point, the pedal arm further comprises a second end opposite the first end, which second end is a free end and comprises a pedal plate;
a first system for simulating at least a pedal feel, comprising a compressible first elongated device for dampening a pivotal movement of the pedal arm around the pivot point, the first elongated device having a longitudinal extension between a first end part coupled to the pedal arm at a first position on the pedal arm, and a second end part coupled to the bracket at a first bracket position on the bracket, the first elongated device comprises at least one first spring parallel to the longitudinal extension of the first elongated device;
a second system for sensing a pedal angle, comprising a movable first part, which in use accompanies the rotational motion of the pedal arm, a stationary second part, wherein the first and the second part are to be arranged radially outside of the pivot point, a magnetic field sensing component arranged in the first or in the second part and a magnetic element arranged in that part of the first or the second part that does not comprise the magnetic field sensing component, wherein the magnetic field sensing component is arranged to generate a first electric signal originating from magnetic interaction between the first and the second part when the first and the second part are moving in relation to each other;
a third system for sensing at least a pedal force, comprising a force sensor arranged at the bracket in a second position (20b) on the bracket, a compressible second elongated device having a longitudinal extension between a first end part coupled to the pedal arm at a second position on the pedal arm, different from the first position, and a second end part connected to the force sensor, the second elongated device comprises at least one second spring parallel to the longitudinal extension of the second elongated device and extending between the first end part and the second end part, wherein the pedal force sensor is arranged to generate a second signal originating from a pedal force acting on the pedal arm and transferred to the force sensor via the second elongated device.

2. The brake pedal system according to claim 1, wherein the second system is arranged to send the first electric signal of the second system to a vehicle ECU as a response to a brake request to control a braking action, and the third system is arranged to send the second electric signal of the third system to the vehicle ECU as a response to a brake request.

3. The brake pedal system according to claim 1, wherein the second system is arranged to act as a master system wherein the first electric signal of the second system is sent to a vehicle ECU as a response to a brake request to control a braking action, and the third system is arranged to act as a backup system of the second system, wherein the second electric signal of the third system is sent to the vehicle ECU as a response to a brake request, wherein the second electric signal of the third system is used to control a braking action if the first electric signal of the second system is not sent to the vehicle ECU.

4. The brake pedal system according to claim 2, wherein the vehicle ECU is a first ECU and a second ECU, wherein the first electric signal of the second system is sent to a first vehicle ECU, and the second electric signal of third system is sent to a second vehicle ECU.

5. The brake pedal system according to claim 1, wherein the first position on the pedal arm, to which the first elongated device of the first system is coupled to the pedal arm with its first end part, is arranged between the first and the second end of the pedal arm at a first distance from the pivot point, and the at least one first spring of the first elongated device of the first system has a first spring rate, wherein the first distance and the first spring rate of the at least one first spring together defines a first pedal feel curve of the brake pedal of the brake pedal system.

6. The brake pedal system according to claim 1, wherein the second position on the pedal arm, to which the second elongated device of the third system is coupled to the pedal arm with its first end part, is arranged between the first and the second end of the pedal arm at a second distance from the pivot point, and the at least one second spring of the second elongated device of the third system has a second spring rate, wherein the second distance and the second spring rate of the at least one second spring together defines a second pedal feel curve of the brake pedal of the brake pedal system.

7. The brake pedal system according to claim 6, wherein the first position on the pedal arm, to which the first elongated device of the first system is coupled to the pedal arm with its first end part, is arranged between the first and the second end of the pedal arm at a first distance from the pivot point, and the at least one first spring of the first elongated device of the first system has a first spring rate, wherein the first distance and the first spring rate of the at least one first spring together defines a first pedal feel curve of the brake pedal of the brake pedal system, and wherein the first pedal feel curve of the first system and the second pedal feel curve of the third system together defines a total pedal feel curve of the brake pedal of the brake pedal system.

8. The brake pedal system, according to claim 1, wherein the first position on the pedal arm, to which the first elongated device of the first system is coupled to the pedal arm with its first end part, is arranged on a first side of the pedal arm, and the second position on the pedal arm, to which the second elongated device of the third system is coupled to the pedal arm with its first end part, is arranged on a second side of the pedal arm, which second side is opposite the first side of the pedal arm.

9. The brake pedal system, according to claim 1, wherein the pedal arm comprises at least one shaft which extends through the pedal arm at the first position and the second position.

10. The brake pedal system, according to claim 1, wherein the pedal arm comprises at least two shafts wherein one shaft is arranged on the first side of the pedal arm in the first position on the pedal arm, and the other shaft is arranged on the second side of the pedal arm in the second position on the pedal arm.

11. The brake pedal system according to claim 1, wherein the first end part of the second elongated device of the third system comprises a first guide which protrudes towards the second end part of the second elongated device, and the second end part comprises a second guide which protrudes towards the first end part of the second elongated device, wherein the first and second guides are telescopically arranged relative each other, and wherein the second spring of the second elongated device is arranged radially outside the first and second guides.

12. The brake pedal system according to claim 1, wherein the compressible first elongated device of the first system further comprises:
a first guide firmly connected to first end and protrudes towards the second end of the elongated device,
a second guide firmly connected to the second end and protrudes towards the first end of the elongated device, wherein the first and second guides are telescopically arranged relative each other wherein the first guide encloses a part of the second guide,
the at least one first spring is a plurality of coil springs, wherein a first coil spring is arranged around at least a part of the first guide and a second coil spring is arranged around at least a part of the second guide,
a first sleeve arranged around at least a part of the first coil spring,
a second sleeve arranged around at least a part of the second coil spring,
wherein the first coil spring is clamped between the first end of the elongated device and an inside end of the first sleeve, and the second coil spring is clamped between the second end of the elongated device and an inside end of the second sleeve,
a third coil spring arranged around at least a part of the first and second sleeves and which third coil spring is clamped between first and second sleeves.

13. The brake pedal system according to claim 12, further comprising one or more friction elements arranged between at least one of the first and second coil springs and the corresponding enclosing first and second sleeves.
